(19) United States
(12) Patent Application Publication
(10) Pub. No.: US 2010/0258479 A1
(43) Pub. Date: Oct. 14, 2010

(54) THERMAL DISSOLUTION CATALYSIS METHOD FOR PREPARING LIQUID FUEL FROM LIGNITE AND THE CATALYST AND THE SOLVENT SUITABLE FOR THE METHOD

(75) Inventors: Ke Wu, Zhaoqing City (CN); Chong Chen, Zhaoqing City (CN); Wenyi Huang, Zhaoqing City (CN); Pai Peng, Zhaoqing City (CN); Chunlai Wu, Zhaoqing City (CN)

Correspondence Address: SCHMEISER, OLSEN & WATTS, 22 CENTURY HILL DRIVE, SUITE 302, LATHAM, NY, 12110, US

(73) Assignee: ZHAOQING SHUNXIN COAL CHEMICAL INDUSTRY S.T. CO. LTD., ZHAOQING CITY, GUANGDONG (CN)

(21) Appl. No.: 12/746,583

(22) PCT Filed: Dec. 10, 2008
(86) PCT No.: PCT/CN2008/073426

§ 371 Date: Jun. 7, 2010

(30) Foreign Application Priority Data
Dec. 13, 2007 (CN) 200710032428.4

(51) Int. Cl. C10G 1/00; C10G 1/06; B01J 31/12; B01F 1/00

(52) U.S. Cl. 208/431; 208/435; 502/161; 252/364

(57) ABSTRACT

The present invention relates to coal chemical processing, and particularly to a thermal dissolution catalysis method for preparing liquid fuel from lignite. The method comprises steps of: 1) crushing and drying lignite into coal powder; 2) stirring and mixing coal powder, a solvent and a catalyst sufficiently to form coal slurry, wherein there are 30-40% mass of coal powder, 60-70% mass of solvent, and 0.5-1% mass of catalyst relative to coal powder mass; 3) subjecting the coal slurry to thermal dissolution catalysis reaction to obtain thermal dissolution liquefied product, wherein the reaction is carried out for 30-60 minutes at a temperature 390-450° C. under a pressure 5.0-9.0 MPa; 4) separating the thermal dissolution liquefied product into gas, liquid and solid phases; and 5) upgrading the liquid product into liquid fuel. The present invention further discloses a catalyst and a solvent for use in the above method. The method according to the present invention requires moderate operation conditions and can enable organic matter in the lignite to convert at a relatively high level, the liquid fuel product, after being processed, can be used to prepare engine fuel meeting a national standard; the method requires a simple preparation apparatus, a small investment and a low cost and is a coal liquefying method meeting China's status quo.

### FIELD OF THE INVENTION

The present invention relates to coal chemical processing, and particularly to a thermal dissolution catalysis method for preparing liquid fuel from lignite and the catalyst and the solvent suitable for the method.

### BACKGROUND OF THE INVENTION

A survey of documents in China and abroad reveals that prior-art processes for preparing liquid fuel from coal are chiefly classified into the following three kinds: (1) pyrolysis process (low-temperature, high-temperature destructive distillation) of coal: the basis procedure of this process is decomposing and polymerizing coal under thermal action generally under an atmospheric pressure and at over 400° C. to obtain coal gas full of hydrogen, low-molecular liquid tar and coke. This process is relatively mature but disadvantageous in a low organic matter transformation rate and serious pollution during processing; (2) direct liquefying process of coal: the basis procedure of this process is gasifying coal into a synthesis gas (CO and H2) and preparing liquid fuel through Fischer-Tropsch Reaction under catalysis of chalybeate, cobalt catalyst and ruthenium catalyst. But this process is disadvantageous in a complicated procedure, a large investment, high cost and high technical requirements; (3) high-pressure hydroliquefaction process of coal which is characterized by destructing high molecular chemical structure of coal and adding hydrogen under a high pressure (10-30 MPa), at a high temperature (450-500° C.) and under action of catalysts. However, this process is disadvantageous in harsh conditions, high requirements for equipment, large investment and a high cost. In addition, there is a process of preparing diesel substitute by thermally dissolving coal by using an assistant and an accelerator. This process is simple but with a low oil yielding rate, the product thereof cannot be directly used and must be formulated with kerosene or methyl alcohol, so it is called diesel substitute.

### SUMMARY OF THE INVENTION

A first object of the present invention is to provide a thermal dissolution catalysis method for preparing liquid fuel from lignite in view of the drawbacks in the prior art.

A second object of the present invention is to provide a catalyst for use in the above thermal dissolution catalysis method.

A third object of the present invention is to provide a circulating solvent for use in the above thermal dissolution catalysis method.

In order to achieve the first object, the present invention employs the following technical solution:

A thermal dissolution catalysis method for preparing liquid fuel from lignite, comprising steps of:

1) crushing and drying lignite into coal powder;

2) stirring and mixing coal powder, a solvent and a catalyst sufficiently to form coal slurry, wherein there are 30-40% mass of coal powder, 60-70% mass of solvent, and 0.5-1% mass of catalyst relative to coal powder mass;

3) subjecting the coal slurry to thermal dissolution catalysis reaction to obtain thermal dissolution liquefied product, wherein the reaction is carried out for 30-60 minutes at a temperature 390-450° C. under a pressure 5.0-9.0 MPa;

4) separating the thermal dissolution liquefied product into gas, liquid and solid phases; and

5) upgrading the liquid product into liquid fuel.

Preferably, a circulating solvent obtained by hydrogenerating part of the liquid product obtained in the above step 4) in two stages can be used to substitute the solvent recited in the step 2), wherein a hydrogenerating temperature in the first stage is 280-350° C., a hydrogenerating temperature in the second stage is 310-390° C., a pressure is 6-13 MPa, a hydrogen-oil ratio is 300-500 (v/v), and a GHSV is 0.2-1.2 h⁻¹.

Preferably, the catalyst in the step 2) can be a halide catalyst, a metal oxide or a liquid catalyst. The liquid catalyst is composed of dimeric acid urea complexed lanthanum 1%-2% by mass, ethylene diamine tetraacetic acid complexed iron 0.5%-5% by mass, glutaric acid urea complexed cobalt 1%-2% by mass, molybdenum iso-caprylate 0.5%-1.5% by mass, boron naphthenate 1.5%-6.0% by mass, and a balance of clarified oil for catalytic cracking in an oil refinery.

Preferably, the solvent in the step 2) is anthracene oil which distillation range is 200-380° C., hydrogen content≧5 m %, carbon content≦91 m % and residue carbon≦0.6 m %.

In order to achieve the second object, the present invention employs the following technical solution:

A catalyst which is used in a thermal dissolution catalysis method for preparing liquid fuel from lignite and which is composed of dimeric acid urea complexed lanthanum 1%-2% by mass, ethylene diamine tetraacetic acid comlexed iron 0.5%-5% by mass, glutaric acid urea complexed cobalt 1%-2% by mass, molybdenum iso-caprylate 0.5%-1.5% by mass, boron naphthenate 1.5%-6.0% by mass, and a balance of clarified oil for catalytic cracking in an oil refinery.

The clarified oil for catalytic cracking in an oil refinery has the following properties: density 927.0-968.0 kg/m³, carbon reside 2%-3 m % and a flash point 160-190° C.; the group composition is: saturated hydrocarbon 35-59 m %, aromatic hydrocarbon 35%-57 m %, colloid 5%-7 m %, and asphaltene 0.5%-2.0 m %.

In order to achieve the third object, the present invention employs the following technical solution:

A solvent which is used in a thermal dissolution catalysis method for preparing liquid fuel from lignite and which is composed of 70%-90% aromatic hydrocarbon, 10%-30% aliphatic hydrocarbon, naphthenic hydrocarbon and derivatives thereof. The aromatic hydrocarbon component is mostly 2-4 ring aromatic hydrocarbon, containing 10%-30% hydride unsaturated aromatic hydrocarbon such as tetrahydronaphthalene, dihydro anthracene and dihydrophenanthrene.

The method according to the present invention requires moderate operation conditions and can enable organic matter in the lignite to convert at a relatively high level, the liquid fuel product, after being processed, can be used to prepare engine fuel meeting a national standard; the method requires a simple preparation apparatus, a small investment and a low cost and is a coal liquefying method meeting China's status quo.

### BRIEF DESCRIPTION OF THE ACCOMPANYING DRAWINGS

FIG. 1 is a flow chat showing a process of a method according to the present invention.

The present invention is further described in detail as follows with reference to the drawings and embodiments.

### DETAILED DESCRIPTION OF PREFERRED EMBODIMENTS

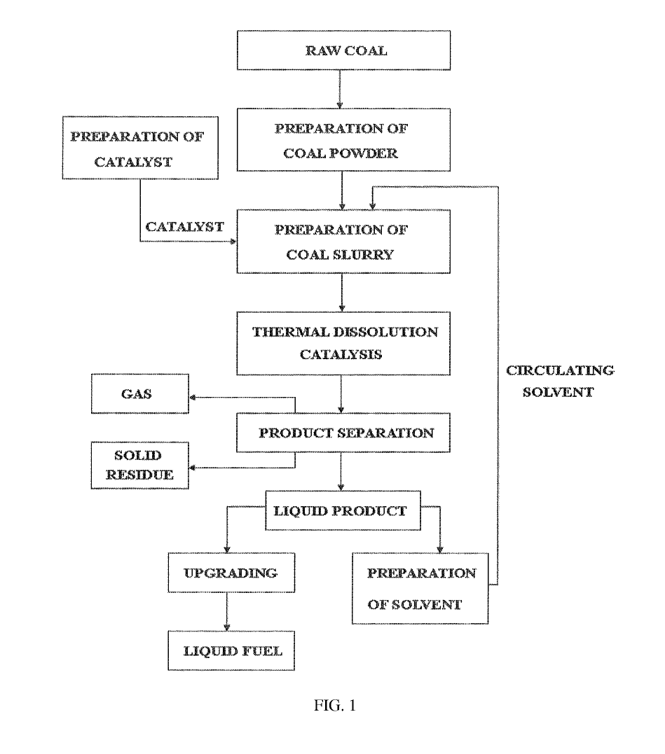

As shown in FIG. 1, the present invention provides a thermal dissolution catalysis method for preparing liquid fuel from lignite, comprising steps of:

1) preparing coal powder: crushing raw coal to 80-200 meshes and drying water content to 2%-5% (m %);

2) preparing coal slurry: adding coal powder and anthracene oil into a coal slurry preparing tank with 30%-40% coal powder and 60%-70% circulating solvent, and then adding a catalyst 0.5%-1.0% by mass (relative to the coal powder mass), wherein the three components are well stirred and mixed to produce coal slurry;

3) liquefaction and catalysis: the coal slurry is subjected to reaction for a period of 30-60 min in a liquefaction reactor at a temperature of 390-450° C. and under a pressure of 5.0-9.0 MPa to obtain a thermal dissolution liquefied product, whereupon the coal is converted into liquid substance;

4) production separation: the thermal dissolution liquefied product in the reactor are separated by a due separation method (such as filtering, solvent extraction, decompression distillation) to produce gas, liquid and solid phases;

5) upgrading: part of the liquid separated from the step 4) is subjected to fractional distillation, hydrofining and catforming to finally produce liquid fuel.

A method for preparing the circulating solvent is as follows: taking part of the liquid product separated from the step 4) and hydrogenerating in two stages: at a hydrogenerating temperature of 280-350° C. in the first stage and a hydrogenerating temperature of 310-390° C. in the second stage, under a pressure of 6-13 MPa, with a hydrogen-oil ratio of 300-500(v/v), and at a GHSV of 0.2-1.2 h⁻¹, hydrogenation is properly done to obtain a solvent. If the solvent meets the indexes: a density 0.96-0.98 g/l, a distillation range 200-400° C. and a hydrogen content (m %) 7.6%-10%, the solvent, as a circulating solvent in place of the anthracene oil, goes to the step 2) of the above method for preparing the coal slurry; if the solvent does not meet the above indexes, it will return to the step of preparing the circulating solvent for hydrotreatment again. The catalyst needed in preparation of the circulating solvent is an ordinary industrial oil hydrotreating catalyst, for example, hydrofining catalyst FRIPP3926 and FRIPP3936 developed by Fushun Petrochemical Research Institute.

The above circulating solvent is composed of 70%-90% aromatic hydrocarbon (mostly 2-4 ring aromatic hydrocarbon) and a balance of aliphatic hydrocarbon, naphthenic hydrocarbon and derivatives thereof. The aromatic hydrocarbon component contains 10%-30% hydride unsaturated aromatic hydrocarbon such as tetrahydronaphthalene, dihydro anthracene and dihydrophenanthrene.

The catalyst used in the present invention is a liquid catalyst which is composed of dimeric acid urea complexed lanthanum 1%-2%, ethylene diamine tetraacetic acid complexed iron 0.5%-5%, glutaric acid urea complexed cobalt 1%-2%, molybdenum iso-caprylate 0.5%-4.5%, boron naphthenate 1.5%-6.0%, and a balance of clarified oil for catalytic cracking in an oil refinery. The clarified oil for catalytic cracking in an oil refinery has the following properties: density 927.0-968.0 kg/m³, carbon reside 2%-3 m % and a flash point 160-190° C. The group composition is: saturated hydrocarbon 35-59 m %, aromatic hydrocarbon 35%-57 m %, colloid 5%-7 m %, asphaltene 0.5%-2.0 m %. The above liquid catalyst is prepared by the following method: adding the clarified oil for catalytic cracking into a blending pot with a stirring and heating system, heating the clarified oil at an atmospheric pressure to 80-100° C., adding, under a mixing condition, a certain dosage of molybdenum iso-caprylate, glutaric acid urea complexed cobalt and ethylene diamine tetraacetic acid complexed iron, maintaining the temperature at 80-100° C., continuously stirring for 30-60 min, then adding dimeric acid urea complexed lanthanum and boron naphthenate, then continuing to stir until a transparent state, then stop heating, cooling it to the atmospheric temperature under protection of nitrogen, thereby obtaining the liquid catalyst needed in the present invention.

Besides, a halide catalyst or a metal oxide such as ZnI₂, Bi₂O₃ can be employed as the catalyst in the above step 2).

The raw material according to the method is lignite and its proximate analysis and element analysis are presented in Table 1:

TABLE 1
Proximate Analysis and Element Analysis of Lignite used in the Instant
Method

Proximate analysis

| | Mad | Vad | FCad | Aad |
|---|---|---|---|---|
| m % | 20-30 | 35-60 | 30-40 | 5-15 |

| | Element analysis | | | | |
|---|---|---|---|---|---|
| | Cad | Had | Oad | Nad | Sad |
| m % | 50-72 | 4-6 | 18-22 | 1-2 | 0.2-2 |

An initial solvent used in the instant method is anthracene oil which indexes are presented as Table 2:

TABLE 2
Indexes of Initial Solvent used in the Instant Method

| Distillation | Hydrogen content | Carbon content | Carbon residue |
|---|---|---|---|
| range | m % | m % | m % |
| 200-380 | ≧5 | ≦91 | ≦0.6 |

Liquefying conditions and serial numbers used in Examples are presented in Table 3

TABLE 3
Liquefying Conditions and Serial Numbers used in Examples

| | Liquefying Conditions used in Examples | | |
|---|---|---|---|
| | | | Reaction |
| Serial numbers | Temperature/° C. | Pressure/MPa | period/min |
| Liquefying | 390 | 5.0 | 60 |
| condition 1 | | | |
| Liquefying | 450 | 9.0 | 30 |
| condition 2 | | | |
| Liquefying | 410 | 7.0 | 30 |
| condition 3 | | | |

Catalyst serial numbers and compositions used in Examples are presented in Table 4

TABLE 4
Catalyst Serial Numbers and Components used in Examples

| | Component content/m % | | | | | |
|---|---|---|---|---|---|---|
| | | ethylene | | | | |
| | | diamine | | | | |
| | dimeric | tetraacetic | glutaric | | | |
| Catalyst | acid urea | acid | acid urea | | | |
| serial | complexed | complexed | complexed | molybdenum | boron | Clarified |
| number | lanthanum | iron | cobalt | iso-caprylate | naphthenate | oil |
| #1 | 1 | 0.5 | 1 | 0.5 | 1.5 | 95.5 |
| catalyst | | | | | | |
| #2 | 2 | 5 | 2 | 1.5 | 6.0 | 83.5 |
| catalyst | | | | | | |
| #3 | 1.5 | 2 | 1.2 | 1.1 | 3.2 | 91 |
| catalyst | | | | | | |

Conditions for the method for preparing the circulating solvent used in Examples are shown in Table 5.

TABLE 5
Numbered Conditions for the Method for Preparing the Circulating
Solvent used in Examples

| | Conditions for Method for Preparing the Circulating Solvent | | | | |
|---|---|---|---|---|---|
| | | #1 reactor | #2 reactor | | Hydrogen |
| Serial | Pressure/ | Temperature/ | Temperature/ | GHSV/ | oil ratio/ |
| number | MPa | ° C. | ° C. | h⁻¹ | v/v |
| Condition | 6 | 280 | 310 | 0.2 | 300 |
| 1 | | | | | |
| Condition | 13 | 350 | 390 | 1.2 | 600 |
| 2 | | | | | |
| Condition | 10 | 310 | 370 | 0.6 | 500 |
| 3 | | | | | |

### Examples 1-7

The crushed and dried coal powder (particles with 80-200 meshes and water content 2%-5%) and the circulating solvent generated by the present method itself which are formulated in a proportion according to the present method, and a certain amount of catalyst are added to a coal slurry preparing tank in which they are sufficiently stirred and mixed to prepare the coal slurry used by the method. The coal slurry is fed into a thermal dissolution catalysis reactor and goes through a reaction under a liquefying condition of the present method. The reactants out of the reactor enters a separating device and separated into materials in gas, liquid and sold phases, wherein gas, after meeting the environmental protection requirements after treatment, enters a heat supply system as a fuel gas, solid material, as liquefaction residue, enters a residue treatment system; and the liquid material partly enters a circulating solvent preparation device to produce the circulating solvent needed in the present method, and partly enters an upgrading device to produce a liquid fuel oil product needed in the present method.

The circulating solvent is prepared in the following procedure: part of the liquid product (viz., solvent) and hydrogen are pressurized and mixed, then, after being heated, enter a first reactor R1. A protective-type catalyst with a relatively low hydrogenation activity is filled in R1, the bed layer is at a low temperature, the solvent and hydrogen pass R1 in an upper stream manner, most of S, N, O and metallic impurities in the solvent are removed after catalystic hydrogenation, high-temperature unsaturated substances such as asphaltene and polycyclic aromatic hydrocarbons liable to high-temperature condensation reaction are subjected to pre-hydrogeneration reaction to weaken a condensation reaction tendency of these substances. The gas-liquid mixture upon completion of the pre-hydrogeneration reaction is discharged from a bottom of R1 and enters a second reaction R2 through a bottom thereof. A catalyst with a high hydrogenerating activity is filled in R2 and a bed layer thereof is at a relatively high temperature. Since hydrogen concentration is reduced after the gas phase goes through R1 reaction, a chemical environment more suitable for unsaturated hydrogenation reaction of the solvent is formed at the bed layer of R2, the gas-liquid mixture passes R2 in an upper stream manner, the liquid flow speed is lower than the gas flow speed, and liquid flow is approximate to a piston flow state and overflows the bed layer, the solvent is in sufficient contact with the catalyst. At an appropriate reaction pressure and temperature, catalystic hydrogenation/dehydrogenation reversible reaction between hydrogen and solvent molecules achieves a balance, the unsaturated substance in the solvent is properly hydrogenerated, a small amount of saturated substance from the coal-liquefied product is properly dehydrogenated, the hydrogenerated solvent achieves an incomplete hydrogenation saturation in molecular structure, and a product releasing free hydrogen (—H) to a maximum degree can be formed under a high-temperature anaerobic environment. The gas-liquid mixture upon completion of hydrogenation reaction is separated to obtain the circulating solvent needed in the present method.

Experimental conditions and results of Examples are shown in Table 6.

Among operation conditions of the Examples listed in Table 6, Example 1 has the most moderate conditions as follows: a liquefying temperature of 390° C., a pressure of 5.0 MPa, preparation conditions of the circulating solvent: a pressure 6.0 MPa, a first reactor temperature 280° C., a second reactor temperature 310° C., a hydrogen-oil ratio 300 (v/v) and a GHSV 0.2 h-1; a minimum content of active components in the catalyst: dimeric acid urea complexed lanthanum 1%, ethylene diamine tetraacetic acid complexed iron 0.5%, glutaric acid urea complexed cobalt 1%, molybdenum iso-caprylate 0.5%, boron naphthenate 1.5%. Conditions of Example 4 are the most severe: a liquefying temperature 450° C., a pressure 9.0 MPa, preparation conditions of the circulating solvent: a pressure 13.0 MPa, a first reactor temperature 350° C., a second reactor temperature 390° C., a hydrogen-oil ratio 600 (v/v) and a GHSV 1.2 h-1; a maximum content of active components in the catalyst: dimeric acid urea complexed lanthanum 2%, ethylene diamine tetraacetic acid complexed iron 5%, glutaric acid urea complexed cobalt 2%, molybdenum iso-caprylate 1.5%, boron naphthenate 6.0%.

it can be seen from the data listed in Table 6 that when conditions are relatively moderate, a 30%-40% distilled oil yield rate can be obtained by the liquefying method. These Examples also sufficiently illustrate the characteristics of the present method: moderate operation conditions and a stable stilled oil yield rate.

| | | | | | Serial | | |
|---|---|---|---|---|---|---|---|
| | Coal slurry components/g | | | | numbers of | | |
| | | | Catalyst | | Preparation | | |
| | | | dosage | Liquefying | conditions | | |
| | | | *and | condition | of | | Distilled |
| Example | Coal | Circulating | serial | serial | circulating | Distilled | oil yield |
| Number | powder | solvents | number | number | solvent | oil/g | rate*/daf % |
| 1 | 300.6 | 701.2 | 3.1, #1 | Liquefying | Initial | 33.9 | 13.3 |
| | | | | condition 1 | solvent | | |
| 2 | 302.2 | 702.3 | 3.1, #1 | Liquefying | Preparation | 77.4 | 30.2 |
| | | | | condition 1 | condition 1 | | |
| 3 | 300.9 | 701.5 | 3.2, #2 | Liquefying | Preparation | 103.3 | 40.5 |
| | | | | condition 2 | condition 2 | | |
| 4 | 400.1 | 600.3 | 4.1, #2 | Liquefying | Preparation | 114.0 | 33.6 |
| | | | | condition 1 | condition 1 | | |
| 5 | 402.7 | 603.8 | 4.4, #2 | Liquefying | Preparation | 128.4 | 37.6 |
| | | | | condition 2 | condition 2 | | |
| 6 | 303.5 | 705.6 | 3.6, #3 | Liquefying | Preparation | 93.7 | 36.4 |
| | | | | condition 3 | condition 3 | | |
| 7 | 404.6 | 603.8 | 4.5, #3 | Liquefying | Preparation | 122.8 | 35.8 |
| | | | | condition 3 | condition 3 | | |
| 8 | 353 | 656 | 3.6, #2 | Liquefying | Preparation | 114.6 | 38.3 |
| | | | | condition 2 | condition 2 | | |

Notes
*a percentage of the catalyst dosage relative to the coal powder mass;

The distilled oil yield rate takes dry ash-free basis coal as a benchmark;

Coal industrial analysis used in the method (m %) is: water content 2.7%, and ash content 12.5%.

1. A thermal dissolution catalysis method for preparing liquid fuel from lignite, characterized in that it comprises steps of:
a) crushing and drying lignite into coal powder;
b) stirring and mixing coal powder, a solvent and a catalyst sufficiently to form coal slurry, wherein there are 30-40% mass of coal powder, 60-70% mass of solvent, and 0.5-1% mass of catalyst relative to coal powder mass;
c) subjecting the coal slurry to thermal dissolution catalysis reaction to obtain thermal dissolution liquefied product, wherein the reaction is carried out for 30-60 minutes at a temperature 390-450° C. under a pressure 5.0-9.0 MPa;
d) separating the thermal dissolution liquefied product into gas, liquid and solid phases; and
e) upgrading the liquid product into liquid fuel.

2. The method according to claim 1, characterized in that a circulating solvent obtained by hydrogenerating part of the liquid product obtained in the above step d) in two stages can be used to substitute the solvent recited in the step b), wherein a hydrogenerating temperature in the first stage is 280-350° C., a hydrogenerating temperature in the second stage is 310-390° C., a pressure is 6-13 MPa, a hydrogen-oil ratio is 300-500(v/v), and a GHSV is 0.2-1.2 h⁻¹.

3. The method according to claim 1, characterized in that the catalyst in the step b) can be a halide catalyst, a metal oxide or a liquid catalyst, the liquid catalyst is composed of dimeric acid urea complexed lanthanum 1%-2% by mass, ethylene diamine tetraacetic acid complexed iron 0.5%-5% by mass, glutaric acid urea complexed cobalt 1%-2% by mass, molybdenum iso-caprylate 0.5%-1.5% by mass, boron naphthenate 1.5%-6.0% by mass, and a balance of clarified oil for catalytic cracking in an oil refinery.

4. The method according to claim 1, characterized in that the solvent in the step b) is anthracene oil which distillation range is 200-380° C., hydrogen content≧5 m %, carbon content≦91 m % and residue carbon≦0.6 m %.

5. A catalyst which is used in a thermal dissolution catalysis method for preparing liquid fuel from lignite and which is composed of dimeric acid urea complexed lanthanum 1%-2% by mass, ethylene diamine tetraacetic acid complexed iron 0.5%-5% by mass, glutaric acid urea complexed cobalt 1%-2% by mass, molybdenum iso-caprylate 0.5%-1.5% by mass, boron naphthenate 1.5%-6.0% by mass, and a balance of clarified oil for catalytic cracking in an oil refinery.

6. The catalyst according to claim 5, characterized in that the clarified oil for catalytic cracking in an oil refinery has the following properties: density 927.0-968.0 kg/m³, carbon reside 2%-3 m % and a flash point 160-190° C.; the group composition is: saturated hydrocarbon 35-59 m %, aromatic hydrocarbon 35%-57 m %, colloid 5%-7 m %, and asphaltene 0.5%-2.0 m %.

7. A solvent which is used in a thermal dissolution catalysis method for preparing liquid fuel from lignite and which is composed of 70%-90% aromatic hydrocarbon by mass, 10%-30% aliphatic hydrocarbon by mass, naphthenic hydrocarbon and derivatives thereof, and in that the aromatic hydrocarbon component is mostly 2-4 ring aromatic hydrocarbon, containing 10%-30% hydride unsaturated aromatic hydrocarbon.
